(19) United States
(12) Patent Application Publication
(10) Pub. No.: US 2010/0105453 A1
(43) Pub. Date: Apr. 29, 2010

(54) GAME SYSTEM WITH VARIABLE ACTION CONTROLS

(76) Inventor: Fabrice Madigou, Andresy (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/922,177

(22) PCT Filed: Jun. 17, 2005
(86) PCT No.: PCT/FR2005/001516

§ 371 Date: Aug. 7, 2009

(30) Foreign Application Priority Data
Jun. 17, 2004 (FR) 0406607

(51) Int. Cl. A63F 9/24; A63F 13/00

(52) U.S. Cl. 463/1; 463/30; 463/37

(57) ABSTRACT

The invention concerns an electronic game system (10) comprising an electronic platform (120) capable of being stably positioned during a game by a user in at least two desired inclinations, said platform including a central processing unit (210) connected to storage means and a display device (100), the system (10) further comprising means for determining a position based on the signal propagation time (510) between at least one provided gamepad (110) and said platform (120), said at least one provided gamepad providing, through a wireless transmitter (140), action data identified by said processing unit while a gaming programme is executed, said actions controlling in particular the movements of virtual objects (111) displayed on the display device (100), and being generated by monitoring the button-type directing means and/or by moving said at least one provided gamepad in space. The invention is characterized in that it comprises a transformation unit for converting the action data into commands which differ depending on the position of said at least one provided gamepad (110) relative to said display device (100) and depending on the inclination of the electronic game platform (120).

The present invention relates to an electronic game system.

In general the electronic game systems proposed previously include at least one game pad, and an electronic platform that in particular includes a display device, a central unit for the processing of digital data, and storage means.

Each game pad is capable of generating control information for actions relating to virtual objects displayed on the display device.

By way of an example, this can concern actions for the movement of the virtual objects.

To this end, a user is in possession of in item, such as a game pad, capable of being operated in two directions, left to right and front to rear, in order to control a desired movement of a virtual object displayed on said display device.

A typical game pad also has a certain number of buttons, each intended to control specific actions such as a jump, a menu selection, etc.

One limitation of a large number of known electronic game systems is that the action information supplied by the game pad does not depend on the position of the latter in relation to the display device, typically a screen on which the game is projected. For example, in the case of a game console or of a game on a computer, the display device is placed vertically in relation to the player or players, and the* players who generally use game pads are therefore always positioned in the same manner in relation to the screen, that is directly in front of it.

As a consequence, the control buttons located on the game pad always act in the same way, whatever its position in relation to the display device.

To some extent, document WO00220110 eliminated this drawback by proposing a game pad in which the actions of the movement members depend upon the side of the box at which the set of user interface elements is usable.

For example, when a first player is sitting in front of a horizontal display device, and when he uses a “forward” button of his game pad, the virtual object associated with this player, or more precisely associated with the game pad that he his holding, and displayed on the display device, moves away from him.

A second player, located to the left of the first player and who uses the “forward” button of his own game pad, sees on the display device a second virtual object which corresponds to him, and which moves away from him in like manner. As a consequence, this second virtual object moves to the left in relation to the first virtual object, corresponding to the actual relative positions of these two players.

Such a solution can therefore be used to overcome, to some degree at least, the limitation mentioned previously, but it still has certain disadvantages.

In particular, there exist positions in the space around the display device at which the game pad cooperates with the platform only with difficulty.

For example, when the controls or the game pad are located at an angle to the game platform, the actions of the movement members do not execute correctly.

One objective of this present invention is to overcome this disadvantage, and more generally the aforementioned drawbacks.

To this end, it proposes an electronic game system in which the game pads, or more generally the control actuators, cooperate effectively with the platform, and this is the case whatever the position of these game pads in space in relation to said platform.

More precisely, it proposes an electronic game system in which the actions of the movement members depend upon the position of the control actuators and on an angle of the display device of the electronic game platform chosen by a player.

More precisely again, it proposes an electronic game system that includes an electronic platform that can be positioned in a stable manner in the course of a user game, in one of at least two desired angles, where said platform has a central processing unit connected to storage means and to a display device, where the system also includes means for determining a position from the signal propagation time between at least one game pad and said platform, with said at least one game pad supplying, by means of at least one wireless transmitter, action information that is recognised by said processing unit during the execution of a game program, and where these actions in particular control the movements of virtual objects displayed on the display device, and generated by controlling direction members of the direction button type and/or by moving said game pad at least in space, characterised in that it includes a conversion unit for converting the action information into controls that differ as a function of the position of said at least one game pad in relation to said display device and as a function of the angle of the electronic game platform.

Thus, in this present invention, the action controls advantageously depend on the position of said at least one game pad in space around the display device and on the angle of the latter, or more generally on the platform that supports the latter.

Certain preferred, though not limited, aspects of this system are as follows:
the position of said game pad is at least determined in relation to a reference system, the origin of which is located at the centre of the display device,
the system also includes at least wireless type signal reception means, attached to the platform, said signals being transmitted by means of the wireless transmitter on said game pad, with a view to determining the position of said game pad from at least three observation points each associated with said at least three reception means,
the system includes four wireless type signal reception means, attached to the game platform, said signals being transmitted by means of at least one wireless transmitter on said game pad at least, with a view to determining the position of said game pad from four observation points, each associated with said four reception means,
said four reception means are placed at maximum distances from each other,
said processing means are capable of executing an algorithm that reduces an uncertainty regarding the calculated position of said game pad at least,
the system also includes means for determining an angle of the platform in relation to a plane,
said plan is parallel to the surface of a floor on which said platform is placed,
the means for determining the angle of the platform in relation to a plane is an angle detector attached to the platform,
the means for determining the angle of the platform in relation to a plane is a gravitational position detection and measuring device attached to the platform,
the gravitational position detection and measuring device is a ball switch attached to the platform,
the system also includes an additional reception means associated with the platform and located, in relation to a plane determined by the latter, on the other side of said at least three signal reception means attached to the game platform,
said additional reception means is located at a certain distance from the game platform, and the system also includes a magnetic screen,
the magnetic screen lies in a plane that is chosen so that said additional reception means cannot receive radio signals transmitted by said game pad at least when said game pad and said additional means are located on either side of the display device,
the magnetic screen extends over all or part of the surface of the display device,
said at least one game pad includes means for generating and transmitting information relating to its movement in space, and in that this information concerns pitch, roll and yaw,
the means for generating information relating to pitch and roll are accelerometers, inclinometers, electronic gyroscopes, and two-dimensional electronic compasses,
the means for generating information relating to yaw are magnetic sensors,
said game pad at least includes a display screen,
said game pad at least includes a tactile surface,
the system includes means for determining the position of said at least one game pad by determining its polar coordinates, ρ, θ and φ,
the system includes means for determining the position of said at least one game pad by determining its rectangular coordinates x, y, z,
the transmitters and receivers employed are of the wireless type.

Other aspects, aims and advantages of this present invention will appear more clearly on reading the detailed description that follows of a preferred form of implementation of the latter, which is given by way of a non-limiting example and with reference to the appended drawings, in which:

FIG. 1 illustrates a game pad located in a three-dimensional rectangular coordinate system associated with a display device,

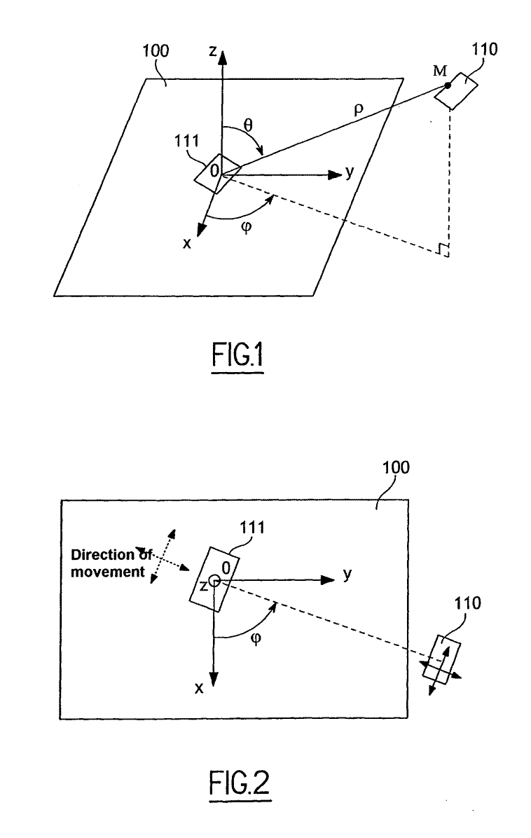

FIG. 2 illustrates possible movements in two dimensions of a virtual object displayed on the display device,

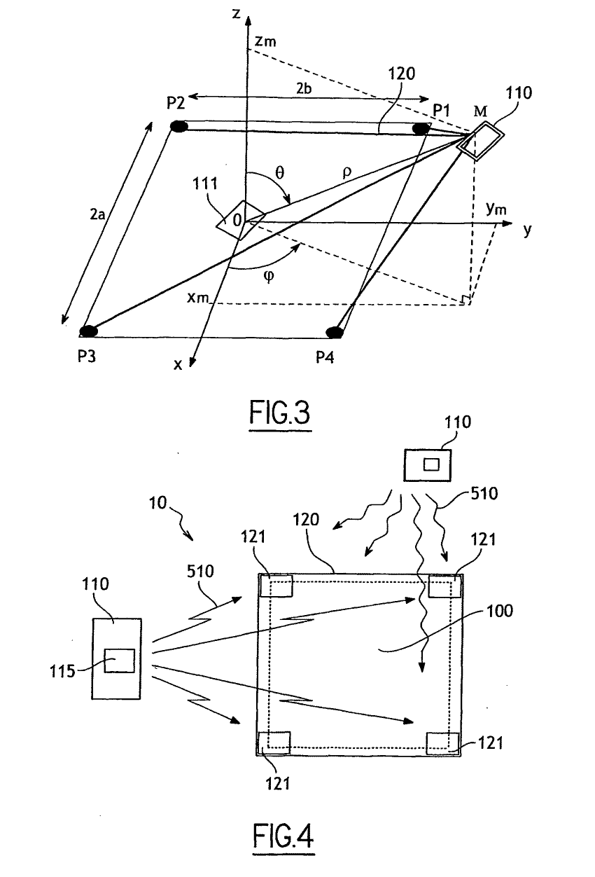

FIG. 3 illustrates an electronic platform according to the invention, with means for measuring the position of the game pad,

FIG. 4 illustrates an electronic platform according to the invention, that includes the display device, four wireless receivers and two wireless game pads with a wireless transmitter,

FIG. 5 schematically illustrates a composition of a game pad according to a first aspect of the invention,

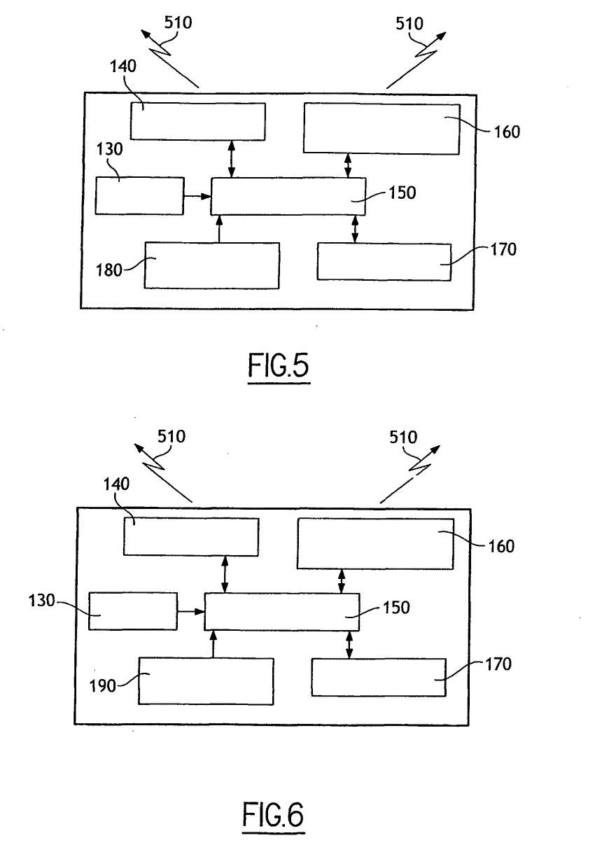

FIG. 6 schematically illustrates a composition of a game pad according to a second aspect of the invention,

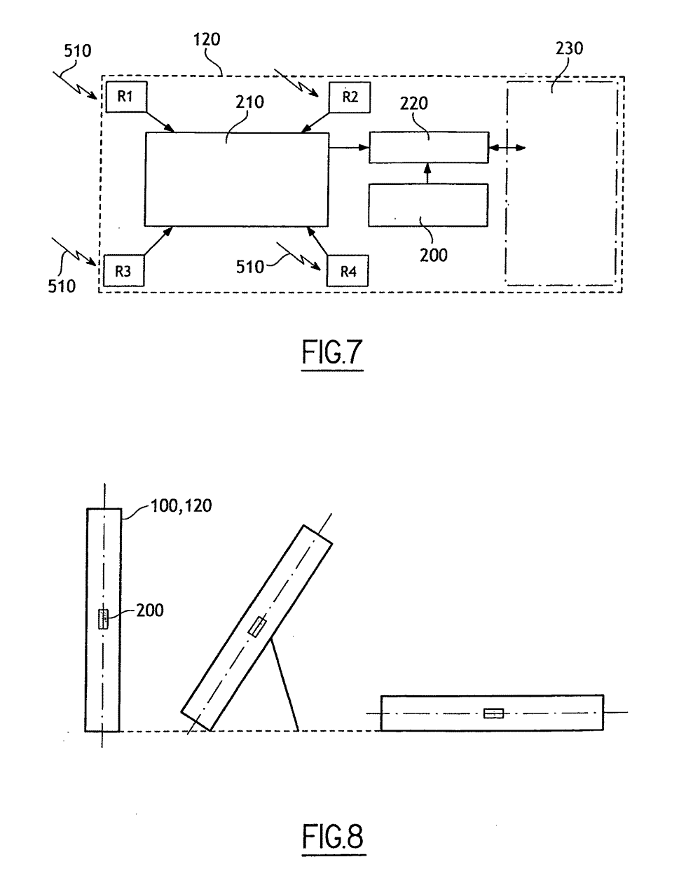

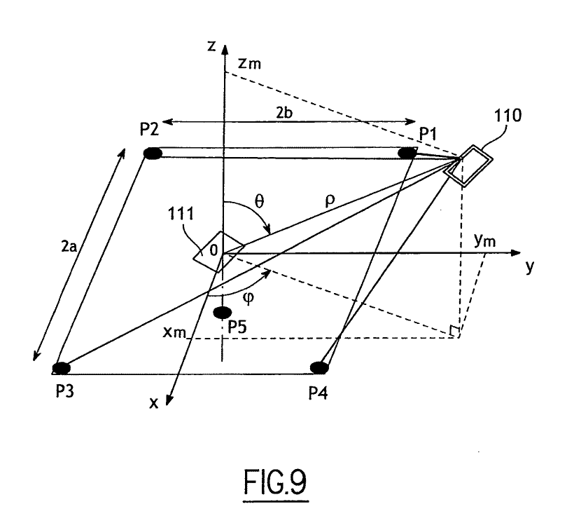

FIG. 7 schematically illustrates a location module associated with the platform,

FIG. 8 represents possible angles of the game platform according to the invention, seen from the side,

FIG. 9 is a view in perspective of the game platform with a fifth sensor,

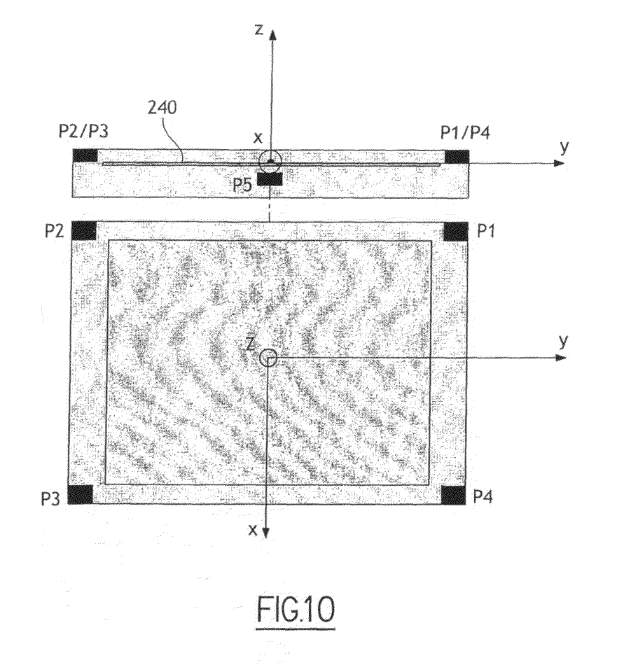

FIG. 10 shows two different views of the game platform of FIG. 9,with a magnetic screen,

FIG. 11 schematically illustrates a rectangular coordinate system associated with a game pad, with a mention of the conventions and the terminology employed,

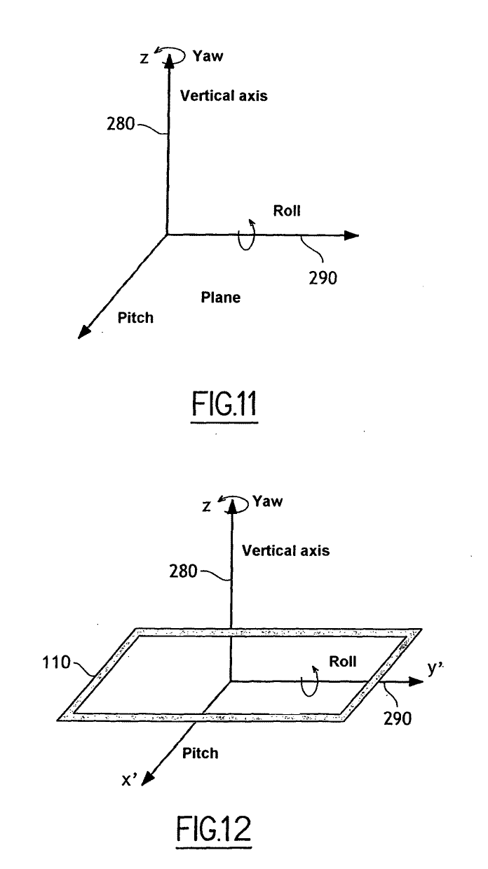

FIG. 12 schematically illustrates the rectangular coordinate system and the game pad, and shows possible movements of the latter,

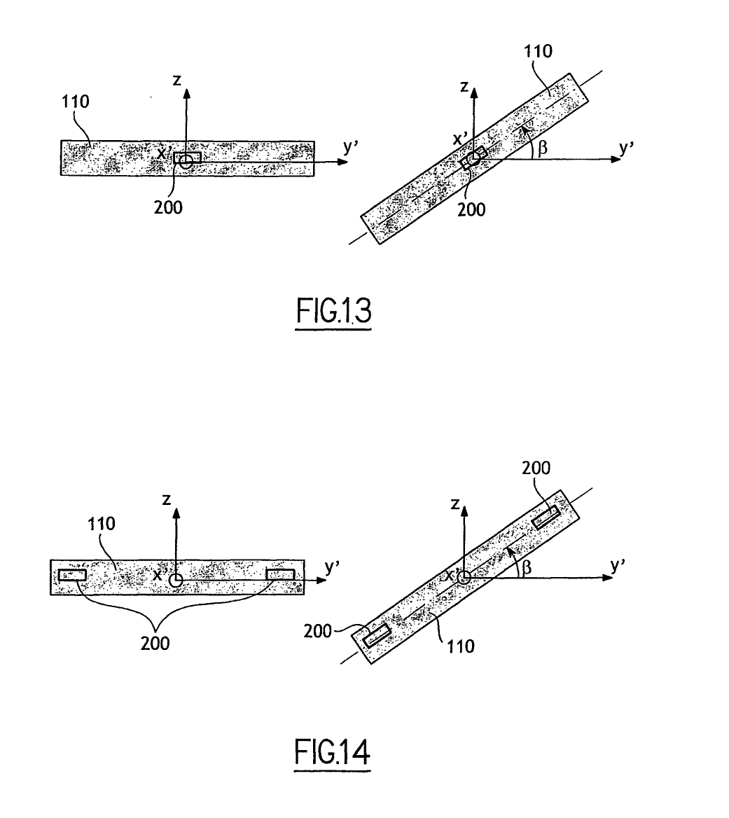

FIG. 13 illustrates the use of an angle sensor in the game pad,

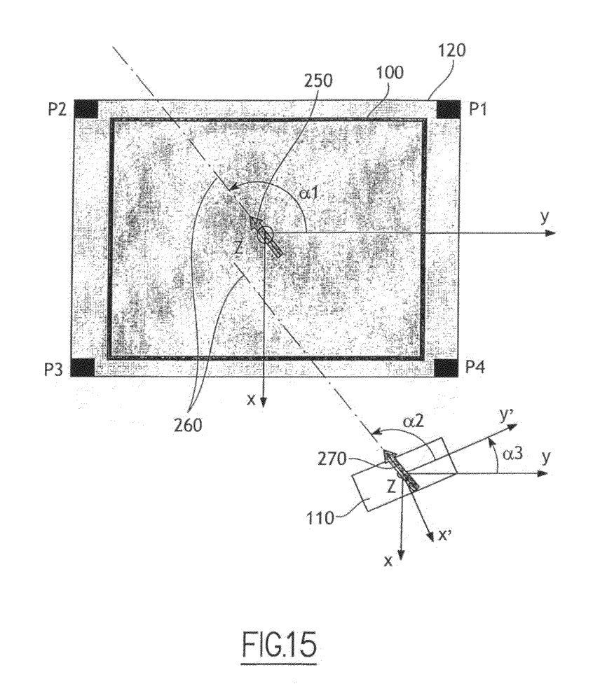

FIG. 14 illustrates the use of two angle sensors in the game pad,

FIG. 15 illustrates a method for measuring the movement of the game pad around an axis, using a magnetic field sensor.

A game platform according to the invention in particular includes a central unit, a memory, a display device capable of adopting an essentially horizontal position, at least one input actuator per user, and means for the emission and/or reception of information by wireless transmission.

In the remainder of this document, it is intended that an input actuator can be a game pad held in the hand by the player, or any module of this type held by this same player.

In particular, this module can be attached to a limb of the player and can include, as in the case of a conventional game pad, special control buttons and other members for the control of movement according to the invention and presented below.

Thus, in what follows, we will speak of a game pad in the game system, although more generally all of this description will equally include any input actuator.

According to a first aspect of the invention, the control actions of a game pad are executed by means of direction buttons located on the game pad.

According to a second aspect of the invention, the control actions of the game pad are executed through relative movements of the game pad in space, allowing one to act in an intuitive manner on the movements of a virtual object located on the display device attached to the platform.

For certain applications, these actions can have different actions according to the position at which the game pads are employed in relation to the platform.

A conversion unit, typically included in the central unit, changes a command generated by an action on the game pad into another command as a function of the position measured.

In a preferred method of implementation of the invention, the actions can have different results according to the position at which the game pads are employed in relation to the centre of the platform. In this regard, use is made in particular of distance measurements, horizontal angles and vertical angles.

More precisely, in the preferred implementation method of this present invention, the actions depend upon the position of each of the game pads in relation to a reference system whose vertical axis z passes through the centre of the display device.

In this regard, FIG. 1 illustrates the display device 100, the game pad 110 and the reference system x, y, z, the origin of which 0 is located at the centre of the device 100.

The system is capable of locating the game pad 110 in relation to the centre of the display device 100 and of determining the polar coordinates ρ, θ and φ of this game pad 110 in the chosen reference system.

Thus the actions can depend on the distance ρ of the game pad in relation to the centre of the display device 100 as well as on the angles θ and φ.

It can be seen that, in the system according to the invention, the angles φ and θ can take values of between 0 and 2π and between 0 and π respectively.

Thus, as shown in FIG. 2, in the case of using directional buttons positioned on said game pad 110, these can be used to move a virtual object 111, displayed by the display device associated with the platform, in plane (x, y) according to the direction of the straight line ρ (image 3D) or along the projection of the straight line ρ in plane (x, y) (image 2D).

In theory, three non-aligned points located on the platform are sufficient to calculate the coordinates of the position of the game pad 110.

Knowledge of the distances between the three points on the platform and a transmitter 115 associated with the game pad, can be used to deduce the coordinates xm, ym, zm of the point M associated with the game pad in relation to said reference system 0, x, y, z.

A measurement of distance can be effected by different methods and in particular by the measurement of relative phase offsets and/or attenuation between signals received by different sensors located on the platform, with these signals being transmitted beforehand by said game pad.

In order to achieve the same measurement accuracy regardless of the position of the game pad 110 in relation to the platform, or in other words in relation to the display device 100, it is preferable to use four points, P1 to P4.

Such a measurement system is represented in FIG. 3.

It can be seen in particular that the system of the invention can be used to achieve such constant precision when a player is positioned at one side of the platform. In addition, the use of four measurement points allows one to overcome poor reception on a receiver due, for example, to the presence of an object between the transmitter and one of the receivers (a metal drinks can for example, located close to a receiver) and to determine the coordinates of the point M associated with the game pad 110 in spite of this presence.

In order to achieve optimal accuracy of the measurements, it is preferable to place these four points, P1 to P4, at maximum distances from each other.

As an example, it is possible to position them at the corners of the platform 120.

A transmitter is located at point M, and four receivers are located respectively at points P1, P2, P3 and P4.

Such a system can therefore be used to ascertain the distances, P1M, P2M, P3M, and P4M (see FIG. 3).

Assuming, for example, that the distance between points P2 and P3 (like P1 and P4) is equal to 2a, and that the distance between points P2 and P1 (like P3 and P4) is equal to 2b, then it is then possible to deduce the following system of equations:

(P1M)²=(xₘ+a)²+(yₘ−b)²+zₘ²

(P2M)²=(xₘ+a)²+(yₘ+b)²+zₘ²

(P3M)²=(xₘ−a)²+(yₘ+b)²+zₘ²

(P4M)²=(xₘ−a)²+(yₘ−b)²+zₘ²

giving the measurements of ρ, θ and φ by solution of this system.

zₘ=ρ cos θ

xₘ=ρ sin θ cos φ

yₘ=ρ sin θ sin φ

The use of four measurement points also results in reducing some uncertainty in measuring the position of point M, and therefore of the game pad, using a numerical processing algorithm.

This present invention naturally includes the use of such a position measuring system with a multiplicity of game pads 110 located around the platform.

As represented in FIG. 4, each game pad 110 successively transmits a location signal 510 to receivers 121 on the platform 120.

This signal can advantageously be a radio signal. However, other technologies known to the professional engineer can be used for communication between transmitter and receiver (infrared communication, for example).

In all of these cases, the transmitted signal employs a personal code and frequency at the game pad so that the latter is easily identifiable by the system.

Furthermore, through the use of a radio signal (a wireless link, for example) and by means of an appropriate transmitter, the platform is also able to transmit the command to each of the active game pads to send said succession of radio location signals 510.

It can be seen that the platform can include as many transmitters as there are receivers or game pads.

For example, it can include four transmitters and four receivers. According to another aspect of the invention, one or more wireless game pads associated with a screen platform can be located around this platform, while the latter is placed vertically, horizontally or even at an angle.

Referring now to FIG. 5, according to a first aspect of the invention, each game pad includes:
action buttons 130
a transmitter 140 generating a signal that is used for the location of the game pad 110 in relation to a reference system of the platform 120,
a processing and communication unit 150,
a wireless transmitter-receiver 160, advantageously of the radio communication type,
a memory area containing an identification number 170 of the game pad 110,
directional control buttons 190,

According to a second aspect of the invention, each game pad includes:
action buttons 130,
a transmitter 140 generating a signal that is used for the location of the game pad 110 in relation to a reference system of the platform 120,
a processing and communication unit 150,
a wireless transmitter-receiver 160 advantageously of the radio communication type,
a memory area containing the identification number 170 of the game pad 110,
a movement and orientation detection system 190.

According to a third aspect, each game pad also includes, in addition to the preceding constituents of the first or second aspects:
a display screen,
a tactile surface associated with the display.

The platform 120 also includes a location module.

This module is represented in FIG. 7.

In particular, it includes receivers R1 to R4, a processing unit 210 for the location receivers, a microcontroller 220, an angle sensor 200 and a general processing unit.

Another aspect of this invention concerns the fact that the actions of the game pad depend upon the position of the platform and more particularly on its angle (see FIG. 8).

By way of a non-limiting example, FIG. 8 illustrates different possible angles of the platform, such as a horizontal or vertical position, or one that is inclined at a certain angle to the floor on which the platform is resting for example.

However the professional engineer will understand that there are obvious possible adaptations of the system in order to change the reference system (an angle with a vertical wall for example).

To detect the vertical or horizontal position of the platform, a simple on/off gravitational position detector (a ball switch for example) can be used.

For certain applications in which the display device can be used at a certain angle, and in which the actions of the game pad or game pads is dependent on this angle, an angle detector 200 is necessary.

Regarding the sign of the coordinate z of the game pad in the reference system 0, x, y, z, the fact that the four measurement points, P1 to P4, are located in the same plane, does not allow this to be determined.

In order to render this determination possible, another aspect of this invention consists of using a fifth location sensor P5, located beneath the platform and not located in the plane formed by the other four sensors P1 to P4. This is illustrated in FIGS. 9 and 10.

Furthermore, an electromagnetic screen 240, placed under the plane (x, y) constituted by sensors P1, P2, P3 and P4, prevents the reception of a signal coming from a transmitter if the latter is located above plane (x, y).

Sensor P5 receives a signal from a game pad only if the latter is located below said plane. Naturally this present invention is not limited to the form of implementation described above.

In particular, for the position signals, another method of implementation of this invention is to use transmitters on the platform and a receiver on each of the game pads, with the latter being capable of analysing the different signals coming from the different transmitters.

Another aspect of the invention consists of associating an orientation and/or movement detection system with the location system, in order to achieve intuitive controls. To this end, each game pad has its own rectangular coordinate system contained in the horizontal plane and the vertical axis with the following conventions and terminology as represented in FIGS. 11 and 12: the vertical axis is common to all of the game pads and corresponds to the z axis of the platform when the latter is used horizontally, while each game pad has its roll and pitch axis.

The angle of the game pad is measured in relation to this coordinate system.

Measuring the angles of tilt in relation to the horizontal (the pitch and roll angles) can be effected by means of different means (such as sensors).

For example, use is made of accelerometers, inclinometers, inertial units, electronic gyroscopes, and two-dimensional electronic compasses.

Sensors 200 of this type are placed in each of the axes of rotation x′ and y′.

As an example, FIG. 13 illustrates one use of an angle sensor 200 around axis x′, and FIG. 14 illustrates the use of two angle sensors 200 placed symmetrically around axis x′, in order to be able to compensate, when using the measurements, for the radial forces associated with the rotation of the game pad around axis x′.

Measuring the orientation of the system around the vertical axis (the yaw angle) can be achieved by gyroscopic measurement or by measuring the orientation of the earth's magnetic field.

In this regard, FIG. 15 illustrates a method for measuring the movement of the game pad 110 around axis z using a magnetic field sensor 270 incorporated into the game pad 110.

In order to ascertain the orientation of the game pad 110 in relation to the platform 120, it is necessary to also associate a terrestrial magnetic field sensor 250 with the platform 120.

As shown in FIG. 15, this is advantageously placed at the centre of the platform.

Knowledge of the angle α1 between the axis of geographic north and axis y associated with the platform 120, as well as knowledge of the angle α2 between the axis of the geographic north and axis y of the game pad allows one to deduce the angle α3 between axis y and axis y′.

From this, it is possible to deduce the orientation of the game pad 110 around the z axis in relation to the platform 120.

The position information on the different axes is transmitted to the platform by the wireless transceiver 160 via the processing and communication unit 150.

Naturally, the system can be used with a multiplicity of game pads.

One possible application of associating the location with the orientation is to reproduce the movements of a game pad on a virtual object 111 placed on the screen of the platform, and thus to move in a three-dimensional space, regardless of the position at which one is located around the platform and whatever the angle of the platform proper.

Naturally, this present invention is in no way limited to the form of implementation described above and represented in the drawings, and the professional engineer will understand that the system presented includes a multiplicity of obvious possible variants.

In particular, we have seen that the wireless communication means are reversible:
with transmitters on the platform and receiver on the game pad,
with transmitters on the game pad and receivers on the platform.

Furthermore, the number of transmitters and receivers employed can vary.

It is possible to have more than four receivers around the platform, for example.

It is also possible to have game pads with more than one wireless transmitter.

1. An electronic game system (10) that includes an electronic platform (120) which can be positioned in a stable manner in the course of a user game, in one of at least two desired angles, where said platform has a central processing unit (210) connected to storage means and to a display device (100), where the system (10) also includes means for determining a position from the signal propagation time (510) between at least one game pad (110) and said platform (120), with said at least one game pad supplying, by means of at least one wireless transmitter (140), action information that is recognised by said processing unit during the execution of a game program, with these actions, in particular control of the movements of virtual objects (111), displayed on the display device (100) and being generated by controlling direction members of the direction button type and/or by moving said at least one game pad in space, characterised in that it includes a conversion unit for converting the action information into commands that differ as a function of the position of said at least one game pad (110) in relation to said display device (100) and as a function of the angle of the electronic game platform (120).

2. An electronic game system according to claim 1, characterised in that the position of said game pad (110) is at least determined in relation to a reference system whose origin is located at the centre of the display device (100).

3. An electronic game system according to one of the preceding claims, characterised in that it also includes at least three reception means (121) of wireless signals (510), attached to the platform, with said signals being transmitted by means of the wireless transmitter (115) on said game pad, with a view to determining the position of said game pad from at least three observation points (P1), each associated with said at least three reception means (121).

4. An electronic game system according to either of claim 1 or 2, characterised in that it includes four reception means (121) of wireless signals (510), attached to the game platform, with said signals being transmitted by means of at least one wireless transmitter (115) on said game pad (110) at least with a view to determining the position of said game pad at least from four observation points (P1), each associated with said four reception means (121).

5. An electronic game system according to claim 4, characterised in that said four reception means (121) are placed at maximum distances from each other.

6. An electronic game system according to one of the preceding claims, characterised in that said processing means (210) are capable of executing an algorithm that reduces an uncertainty regarding the calculated position of said game pad at least.

7. An electronic game system according to one of the preceding claims, characterised in that it also includes means (200) for determining an angle of the platform in relation to a plane.

8. An electronic game system according to claim 7, characterised in that said plane is parallel to the surface of a floor on which said platform is placed.

9. An electronic game system according to either of claim 7 or 8, characterised in that the means (200) for determining the angle of the platform in relation to a plane is an angle detector attached to the platform.

10. An electronic game system according to either of claim 7 or 8, characterised in that the means (200) for determining the angle of the platform in relation to a plane uses a gravitational position detection and measuring device attached to the platform.

11. An electronic game system according to claim 10, characterised in that the gravitational position detection and measuring device includes a ball switch.

12. An electronic game system according to one of the preceding claims, characterised in that it also includes an additional reception means (P5) associated with the platform and located, in relation to a plane determined by the latter, on the other side of said at least three signal reception means (121) attached to the game platform.

13. An electronic game system according to claim 12, characterised in that said additional reception means is located at a certain distance from the game platform.

14. An electronic game system according to one of the preceding claims, characterised in that it also includes a magnetic screen (240).

15. An electronic game system according to claim 14, characterised in that the magnetic screen (240) lies in a plane that is chosen so that said additional reception means (P5) cannot receive radio signals transmitted by said game pad (110) at least when said game pad and said additional means are located on either side of the display device (100).

16. An electronic game system according to claim 14 or 15, characterised in that the magnetic screen (240) extends over all or part of the surface of the display device (100).

17. An electronic game system according to one of the preceding claims, characterised in that said at least one game pad (110) includes means (115) for generating and transmit information relating to its movement in space, and in that this information concerns pitch, roll and yaw.

18. An electronic game system according to claim 17, characterised in that the means (115) for generating information relating to pitch and roll are accelerometers, inclinometers, electronic gyroscopes, and two-dimensional electronic compasses.

19. An electronic game system according to either of claims 17 to 18, characterised in that the means (115) for generating information relating to yaw are magnetic sensors.

20. An electronic game system according to one of the preceding claims, characterised in that said game pad at least includes a display screen.

21. An electronic game system according to one of the preceding claims, characterised in that said game pad (110) at least includes a tactile surface.

22. An electronic game system according to one of the preceding claims, characterised in that it includes means for determining the position of said game pad at least by determining its polar coordinates (ρ, θ and φ).

23. An electronic game system according to one of claims to 22, characterised in that it includes means for determining the position of said game pad at least by determining its rectangular coordinates (x, y, z).

24. An electronic game system according to one of the preceding claims, characterised in that the transmitters and receivers employed are of the wireless type.
